(19) United States
(12) Patent Application Publication
(10) Pub. No.: US 2011/0162375 A1
(43) Pub. Date: Jul. 7, 2011

(54) Secondary Combustion Fuel Supply Systems

(75) Inventor: Jonathan Dwight Berry, Simpsonville, SC (US)

(73) Assignee: General Electric Company, Schenectady, NY (US)

(21) Appl. No.: 12/652,181

(22) Filed: Jan. 5, 2010

(51) Int. Cl. F02C 7/22

(52) U.S. Cl. 60/746; 60/734

(57) ABSTRACT

Systems are provided for supplying fuel to secondary combustion zones within gas turbine engines. In one embodiment, a system includes a transition piece support structure extending from a compressor casing and configured to support a combustor transition piece of a gas turbine engine. A fuel passageway is integrated with the support structure.

### BACKGROUND OF THE INVENTION

The subject matter disclosed herein relates to fuel supply systems for gas turbine engines and more specifically, to fuel supply systems that may be employed to provide fuel to secondary combustion systems within gas turbine engines.

In general, gas turbines combust a mixture of compressed air and fuel to produce hot combustion gases. As higher percentages of compressed air and fuel are combusted, gas turbine engine efficiency may increase. However, combustion temperatures may increase as well, and at high temperatures, compounds such as nitric oxide and nitrogen dioxide (collectively known as NOx) may be formed that are subject to governmental regulations. Accordingly, it may be desirable to inject at least a portion of the fuel downstream of the primary reaction zone, which may allow additional fuel to be combusted without substantially increasing the overall temperature. However, it may be difficult to provide fuel to areas downstream of the primary reaction zone.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a mounting bracket for mounting a combustor transition piece within a gas turbine engine and a fuel passageway integrated with the mounting bracket.

In a second embodiment, a system includes a transition piece support structure extending from a compressor casing and configured to support a combustor transition piece of a gas turbine engine. The system also includes a fuel passageway integrated with the transition piece support structure.

In a third embodiment, a system includes a combustor configured to combust a primary fuel source within a primary reaction zone and to combust a secondary fuel source within a secondary reaction zone downstream of the first reaction zone. The system also includes a primary fuel injector configured to inject the primary fuel source into the primary reaction zone, a secondary fuel injector configured to inject the secondary fuel source into the second reaction zone, a transition piece support structure configured to support a combustor transition piece connecting the combustor to a gas turbine engine, a mounting bracket for mounting the combustor transition piece to the transition piece support structure, and a fuel passageway integrated with the mounting bracket and configured to route the secondary fuel source to the secondary fuel injector.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic flow diagram of an embodiment of a gas turbine engine that may employ a secondary combustion fuel supply system;

FIG. 2 is a sectional view of an embodiment of the gas turbine engine of FIG. 1 sectioned through the longitudinal axis;

FIG. 3 is a cross-sectional view of a portion of the gas turbine engine of FIG. 2 taken within line 3-3 and depicting an embodiment of the combustor and the fuel supply system;

FIG. 4 is a cross-sectional view of a portion of the gas turbine engine of FIG. 3 taken within line 4-4 and depicting an embodiment of the fuel supply system;

FIG. 5 is a cross-sectional view of another embodiment of a fuel supply system that may be employed in the gas turbine engine of FIG. 1;

FIG. 6 is a bottom perspective view of the fuel supply system of FIG. 5 taken along line 6-6; and

FIG. 7 is a bottom perspective view of the fuel supply system of FIG. 4 taken along line 7-7.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to fuel supply systems designed to provide fuel to secondary reaction zones within gas turbine engines. In general, gas turbine engines may include a primary reaction zone that combusts fuel and compressed air to produce hot combustion gases. The hot combustion gases may then flow downstream to a secondary reaction zone where additional fuel may be supplied to promote further combustion. The primary reaction zone may be disposed near the head end (e.g., upstream region) of the combustor, and accordingly, fuel may be supplied to the primary reaction zone through fuel nozzles extending into the combustor from the head end. The secondary reaction zone may be located downstream and farther away from the head end in a portion of the combustor located within the gas turbine engine casing. Accordingly, fuel for the secondary reaction zone may be routed through areas included within the gas turbine engine casing.

The area within the gas turbine engine casing may be subject to vibrations during operation and may be accessed during initial installation and/or during maintenance, to assemble, replace, and/or upgrade components of the gas turbine engine. To avoid obstructing access to gas turbine engine components within the gas turbine engine, it may be desirable to integrate fuel supply passages for the secondary reaction zone into existing components of the gas turbine engine. For example, the fuel passages may be integrated into the mounting structure and/or the mounting bracket for the transition piece of the gas turbine engine. The integration of fuel passages with existing components may provide a stable mounting environment for the fuel passages, which may reduce vibrations. Further, the integration of fuel passages with existing components may allow the fuel passages to be mounted in areas that do not obstruct access to gas turbine engine components within the casing.

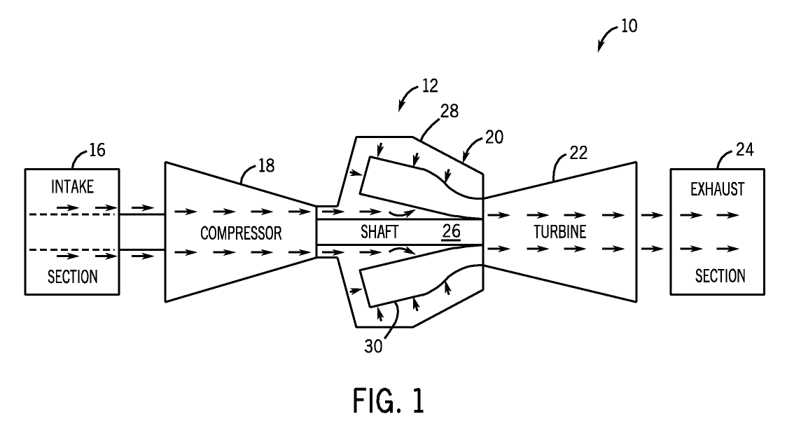

FIG. 1 is a block diagram of an exemplary system 10 including a gas turbine engine 12 that may include integral fuel supply systems. In certain embodiments, the system 10 may include an aircraft, a watercraft, a locomotive, a power generation system, or combinations thereof. The illustrated gas turbine engine 12 includes an air intake section 16, a compressor 18, a combustor section 20, a turbine 22, and an exhaust section 24. The turbine 22 is coupled to the compressor 18 via a shaft 26.

As indicated by the arrows, air may enter the gas turbine engine 12 through the intake section 16 and flow into the compressor 18, which compresses the air prior to entry into the combustor section 20. The illustrated combustor section 20 includes a combustor housing 28 disposed concentrically or annularly about the shaft 26 between the compressor 18 and the turbine 22. The compressed air from the compressor 18 enters combustors 30 where the compressed air may mix and combust with fuel within the combustors 30 to drive the turbine 22. From the combustor section 20, the hot combustion gases flow through the turbine 22, driving the compressor 18 via the shaft 26. For example, the combustion gases may apply motive forces to turbine rotor blades within the turbine 22 to rotate the shaft 26. After flowing through the turbine 22, the hot combustion gases may exit the gas turbine engine 12 through the exhaust section 24.

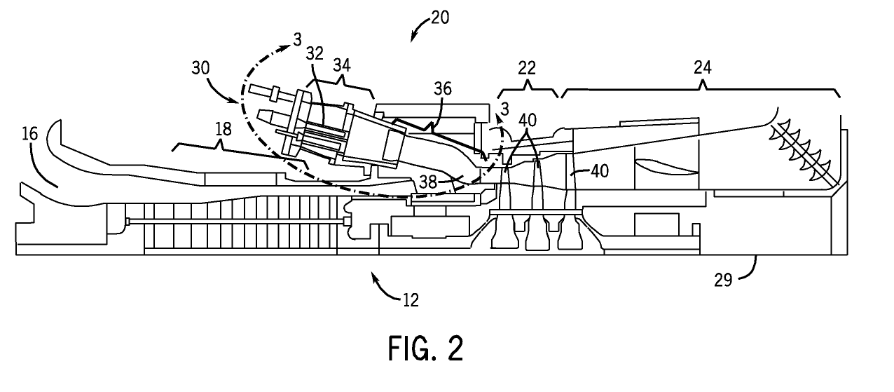

FIG. 2 is a cross-sectional side view of an embodiment of the gas turbine engine 12 of FIG. 1 taken along a longitudinal axis 29. The gas turbine engine 12 includes one or more fuel nozzles 32 located inside the combustor section 20. In certain embodiments, the gas turbine engine 12 may include multiple combustors 30 disposed in an annular arrangement. Further, each combustor 30 may include multiple fuel nozzles 32 attached to or near the head end of each combustor 30 in an annular or other arrangement.

As described above with respect to FIG. 1, air may enter the gas turbine engine 12 through the air intake section 16 and may be compressed by the compressor 18. The compressed air from the compressor 18 may then be directed into the combustor section 20 where the compressed air may be mixed with fuel. For example, the fuel nozzles 32 may inject a fuel-air mixture into the combustors 30 in a suitable ratio for optimal combustion, emissions, fuel consumption, and power output.

Each combustor 30 may include a primary combustion system 34 and a secondary combustion system 36. In general, the fuel nozzles 32 may be part of the primary combustion system 34. Within the primary combustion system 34, the fuel-air mixture may combust to generate hot, pressurized combustion gases. The combustion gases may then enter the secondary combustion system 36 where additional fuel may be injected to further combust the fuel-air mixture. From the secondary combustion system 36, the hot pressurized combustion gases may exit the combustor section 20 and flow through a transition piece 38 to the turbine 22. Within the turbine 22, the pressurized combustion gases may turn blades 40 that extend radially within the turbine 22 to rotate the shaft 26 (FIG. 1) before exiting through the exhaust section 24 as exhaust gas.

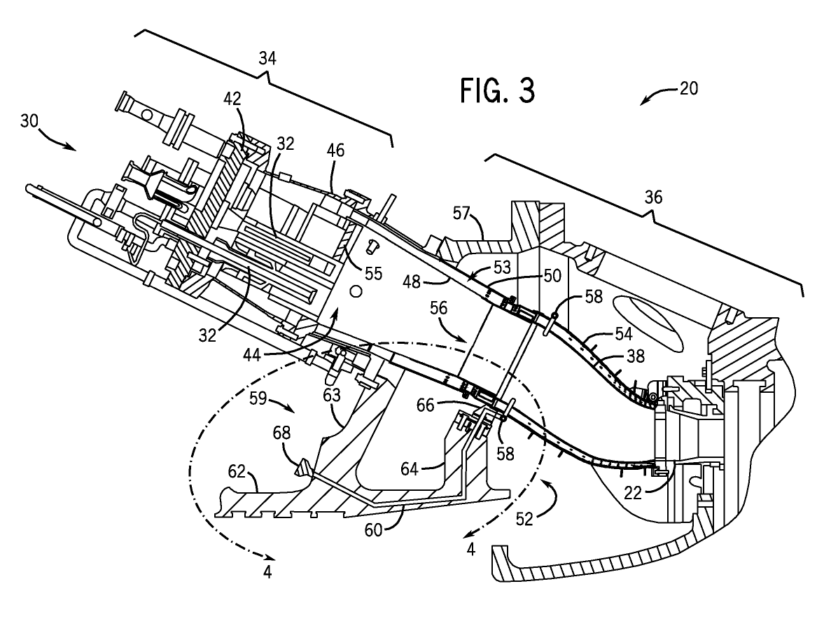

FIG. 3 depicts the combustor section 20 of FIG. 2 and is taken within line 3-3 of FIG. 2. The fuel nozzles 32 are attached to an end cover 42, near a head end of the combustor 30. The primary combustion system 34 includes the fuel nozzles 32, a casing 46, a liner 48, and a flow sleeve 50. Compressed fuel is directed through the end cover 42 to each of the fuel nozzles 32, which distribute the fuel to a primary reaction zone 44 within the primary combustion system 34. Any suitable combustion fuel may be employed. However, according to certain embodiments, the fuel may include synthetic gas (syngas) or other highly reactive fuels (i.e. fuels with low methane and inert content), such as hydrogen, acetylene, ethylene, carbon monoxide, or combinations thereof. Further, liquid and/or gas combustion fuels may be employed.

Air from the compressor 18 (FIG. 2) may enter the combustor 30 through a plenum 52 that directs the air through an impingement sleeve 54 of the transition piece 38. According to certain embodiments, the impingement sleeve 54 may include holes permitting the air to flow into an annular region 53 between the transition piece 38 and the impingement sleeve 54. The air may then flow toward the end cover 42 through the annular region 53 formed between the flow sleeve 50 and the liner 48. As the air reaches the end cover 42, the end cover 42 may direct the air back toward the primary reaction zone 44 and the air may enter the primary reaction zone 44 through fuel nozzles 32 and through holes formed within a cap assembly 55.

Within the primary reaction zone 44, the fuel and air may mix and combust to form combustion gases. Further, an ignition device, such as an electrically energized spark plug, may be included to facilitate combustion. For example, in certain embodiments, the ignition device may be employed upon startup of the gas turbine engine 12. According to certain embodiments, the fuel nozzles 32 may include premixing fuel nozzles that receive a portion of the air and premix the fuel with air prior to directing the fuel into the primary reaction zone 44. Moreover, in certain embodiments, additional components, such as pre-burners, pre-mixers, catalytic pilots, or pilot burners, and the like, may be included within the primary combustion system 34.

From the primary reaction zone 44, the combustion gases may flow through the combustor 30 to the secondary combustion system 36 where further combustion may occur. The secondary combustion system 36 includes a secondary reaction zone 56 that extends within a casing 57 of the gas turbine engine and is generally defined by the liner 48 and the transition piece 38. The secondary combustion system 36 also includes fuel injectors 58 that may inject fuel into the secondary reaction zone 56. The fuel may be ignited by the combustion gases within the secondary reaction zone 56 to promote further combustion. In certain embodiments, the fuel injectors 58 also may inject a diluent, such as air, into the secondary reaction zone 56. The fuel injectors may include lean direct injectors, premixed direct injectors, or combinations thereof, among others. As shown, the fuel injectors 58 extend through the impingement sleeve 54 and the transition piece 38. However, in other embodiments, the fuel injectors 58 may be located farther upstream to extend into the secondary reaction zone 56 through the combustor liner 48. Regardless of their relative position, the fuel injectors 58 may be generally enclosed within the casing 57 of the gas turbine 22.

The combustor section 20 includes a fuel supply system 59 that may be employed to route fuel to the fuel injectors 58 within the secondary combustion system 36. The fuel supply system 59 includes a fuel passage 60 located within a casing 62 of the compressor 18 (FIG. 1). The fuel passage 60 also may extend through support structures 63 and 64 extending from the compressor casing 62. For example, the support structure 63 may generally extend from the compressor casing 62 to support the combustor 30.

According to certain embodiments, the support structure 63 may be coupled to the combustor casing 46 and/or to the combustor flow sleeve 50.

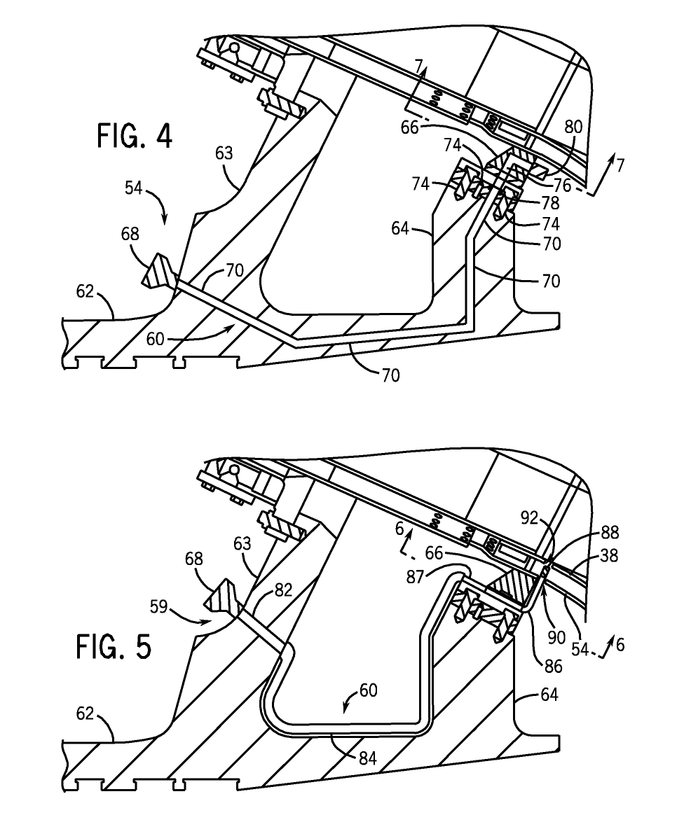

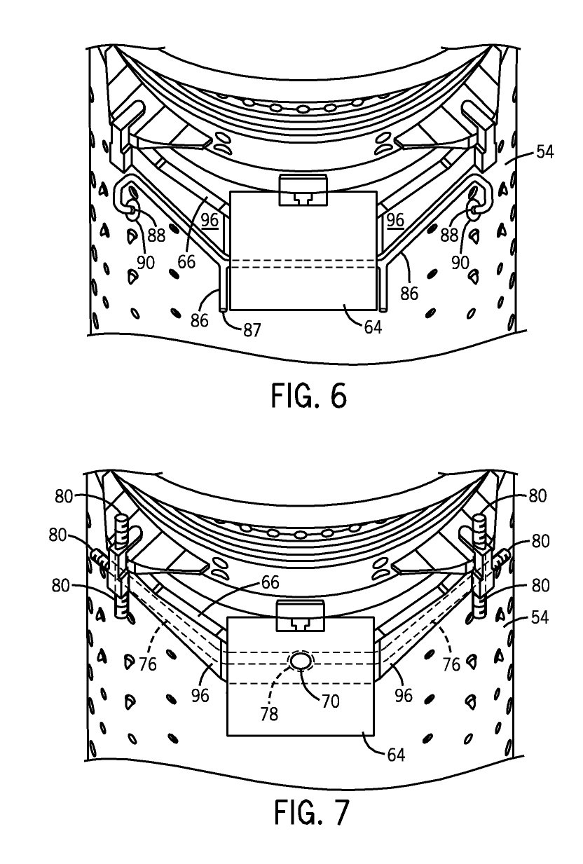

The support structure 64 may generally extend from the casing 62 and may be used to support the transition piece 38 as well as the impingement sleeve 54 that surrounds the transition piece 38. A bracket 66 may extend from the support structure 64 to mount the transition piece 38 between the gas turbine 22 and the combustor 30. According to certain embodiments, the bracket 66 may be a bullhorn shaped bracket, which in the art may be referred to as a bullhorn bracket. In certain embodiments, the bracket 66 may include wings 96 (FIG. 6) extending along surfaces of the transition piece 38. The fuel passage 60 may extend through the compressor casing 62, the support structure 63, the support structure 64, and the bracket 66. According to certain embodiments, the fuel passage 60 may be cast into the compressor casing 62, or may be drilled into the compressor casing, for example using a gun drill. However, in other embodiments, as discussed below with respect to FIGS. 4-7, the fuel passage 60 may be integrated into the compressor casing 62, the support structure 63, and/or the support structure 64 in another manner, such as by a tube affixed to an external surface of the casing 62, the support structure 63, and/or the support structure 64. Moreover, the fuel passage 60 may be an axial and/or circumferential extension of the bracket 66 to enable a connection of the fuel passage 60 to the fuel injectors 58.

A connector 68, such as a flange, may be disposed on the support structure 63 and may be used to couple a fuel supply to the fuel passage 60. For example, in certain embodiments, a connection line or hose may be connected to the connector 68 to connect the fuel passage 60 to the same fuel supply used to provide fuel to the fuel nozzles 32. However, in other embodiments, the connector 68 may be used to connect the fuel passage 60 to a separate fuel supply.

FIG. 4 is a detail view of an embodiment of the fuel supply system 59 of FIG. 3 taken within line 4-4 of FIG. 3. The fuel passage 60 may include several passage sections 70 that may be connected to form the overall fuel passage 60. According to certain embodiments, the passage sections 70 may be cast into the compressor casing 62 and/or into the support structures 63 and 64. In another example, the passage sections 70 may be drilled into the support structures 63 and 64 and/or the compressor casing 62 using a gun drill. According to certain embodiments, the passage sections 70 may be drilled through external surfaces and through an interior of the compressor casing 62, as well as the support structures 63 and 64.

According to certain embodiments the fuel passage 60 may be designed to provide cooling within the compressor casing 62. For example, in operation, as the fuel, which is cooler than the compressor casing 62, is directed through the compressor casing 62, the fuel may absorb heat from the compressor casing 62, thereby cooling the compressor casing 62. In certain embodiments, the fuel passage 60 may include several winding passage sections 70 that increase the length of the fuel passage 60 within the compressor casing 62 to enhance cooling effects. The cooling provided by the fuel passage 60 may decrease thermal expansion of the compressor casing 62, which in turn, may allow the compressor casing 62 to be designed with a tighter fit that reduces fluid leakage through the compressor casing 62.

The fuel passage 60 also may include one or more passages 76 integrated into the bracket 66. For example, the passages 76 may be drilled or otherwise formed within the interior of the bracket 66 and may generally align with a passage section 70 of the support structure 64. A seal 78, such as a C-seal, may be disposed between the bracket 66 and the support structure 64 to facilitate connection of the passage 76 to the passage section 70. Further, a stub or connector 80 may extend from the passages 76 in the bracket 66 to enable connection to the fuel injectors 58. For example, the connector 80 may be threaded and may mate with a complementary threaded end of the fuel injector 58. Further, in certain embodiments, a flexible hose may be employed to connect the connector 80 to the fuel injector 58.

FIG. 5 depicts another embodiment of the fuel passage 60 where certain portions of the fuel passage 60 may extend along external surfaces of the compressor casing 62 and the support structure 63 and 64. The fuel passage 60 includes a passage 82 that extends through the support structure 63. The flange 68 is disposed on the support structure 63 and may be employed to connect the passage 82 to a fuel supply. However, rather than a passage extending within the compressor casing 62, a tube 84 may extend along an external surface of the casing 62. The tube 84 may be a rigid tube, such as a pipe, or a flexible tube, such as a hose. According to certain embodiments, the tube 84 may include a metal tube that may be welded or otherwise joined to the surface of the compressor casing 62. As shown, the tube 84 generally follows the perimeter of the compressor casing 62. However, in other embodiments, the tube 84 may extend between the support structure 63 and 64 such that a space exists between the tube 84 and the compressor casing 62.

The tube 84 may extend from the support structure 63 to the support structure 64, where the tube 84 may extend along the perimeter of the support structure 64 towards the bracket 66. The tube 84 may then connect to a tube 86 that extends along the perimeter of the bracket 66. The tube 86 may include a metal tube that may be welded or otherwise joined to the bracket 66 and/or to the interface surface of the support structure 64. Further, in other embodiments, the tube 86 may include a flexible hose.

The tube 86 may include an end 87 that connects to the tube 84. The tube 86 also may include an opposite end 88 that may connect to the fuel injectors 58. According to certain embodiments, the end 88 may be threaded to facilitate connection of the tube 86 to the fuel injectors 58. Further, in certain embodiments, the end 88 may extend through an opening 90 within the impingement sleeve 54 and may align with a corresponding opening 92 within the transition piece 38. The extension of the end 88 into the impingement sleeve 54 and/or the transition piece 38 may allow the fuel injectors 58 to be disposed within the transition piece 38. The fuel injectors 58 may also extend into the annular space between the impingement sleeve 54 and the transition piece 38 to connect to the end 88. However, in other embodiments, the fuel injectors 58 may be disposed completely within the transition piece 38 while connectors, such as hoses, extend into the annular space between the impingement sleeve 54 and the transition piece 38 to connect the fuel injectors 58 to the ends 88.

FIG. 6 is a bottom perspective view of a portion of the fuel supply system 59 shown in FIG. 5, as indicated by the line 6-6. The bracket 66 includes a pair of wings 96 generally contoured to the impingement sleeve 54 and/or generally contoured to the transition piece 38 extending within the impingement sleeve 54. The tube 86 extends generally along the bracket 66 and includes the end 87 that may be connected to the tube 84 (FIG. 5). As shown, the bracket 66 extends along the surface of the impingement sleeve 54 and may generally support and/or secure the impingement sleeve 54 and the corresponding transition piece 38. As discussed above, the tube 86 may be welded or otherwise joined to the bracket 66, and the ends 88 may extend through the openings 90 within the impingement sleeve 54. The extension of the tube 86 into the openings 90 may facilitate connection of the injectors 58 to the ends 88 and may allow the injectors 58 to extend completely within the impingement sleeve 54. Further, as discussed above with respect to FIG. 5, the opening 90 may align with a corresponding opening 92 within the transition piece 38 allowing the tube end 88 to extend into the transition piece 38.

FIG. 7 is a bottom perspective view of a portion of the fuel supply system 59 shown in FIG. 4, as indicated by the line 7-7. Rather than a tube 86 extending externally along the bracket 66 as shown in FIG. 6, the fuel supply system 59 shown in FIG. 7 includes the internal passages 76, which may be cast, drilled, or otherwise formed internally, within the bracket 66. The passages 76 may connect to the passage sections 70 extending within the support structure 64, as shown in FIG. 4. As discussed above with respect to FIG. 4, the seal 78 may be disposed between the support structure 64 and the bracket 66 to block leakage of fuel at the connection between the passage 76 and the passage section 70. According to certain embodiments, the seal 78 may generally encircle corresponding openings within the bracket 66 and the support structure 64 that define the fuel passages 76 and the fuel passage sections 70.

One or more connectors 80 may extend from the internal passages 76 and may be used to connect the fuel injectors 58 to the passages 76. According to certain embodiments, the connectors 80 may extend from both sides of the bracket 66 allowing injectors to extend into the transition piece 38 on one side of the bracket 66 and into the combustor liner 48 on the opposite side of the bracket 66. However, in other embodiments, the connectors 80 may be disposed on only one side of the bracket 66. Further, the connectors 80 may extend upwards from the bracket 66, which may allow connection to fuel injectors extending into the transition piece 38 and/or the liner 48 at locations farther away from the bracket 66. For example, in certain embodiments, a flexible hose, or other suitable type of connector, may be used to connect the connector 80 to a fuel injector 58 disposed in the transition sleeve 38 radially and/or axially away from the bracket 66. The multiple connectors 80 may allow multiple fuel injectors 58 to be connected to the fuel supply system 59.

The fuel supply systems 59 described herein may employ various types of fuel passages 60 integrated into the compressor casing 62, the support structures 63 and 64, and the bracket 66. As may be appreciated, any combination of internal and external passages may be employed. Further, the number, direction, relative shapes and sizes, and/or the location of the connectors 80 may vary. For example, in certain embodiments, the connectors 80 may extend within the transition piece 38 while in other embodiments, the connector 80 may terminate outside of the transition piece 38 near the bracket 66.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a mounting bracket configured to mount a combustor transition piece within a gas turbine engine; and
a fuel passageway integrated with the mounting bracket.

2. The system of claim 1, wherein the mounting bracket comprises a bullhorn shaped bracket configured to support the combustor transition piece.

3. The system of claim 1, wherein the mounting bracket comprises a pair of wings generally contoured to the combustor transition piece.

4. The system of claim 1, wherein the fuel passageway is internal to the mounting bracket.

5. The system of claim 1, wherein the fuel passageway comprises a tube coupled to an exterior of the mounting bracket.

6. The system of claim 1, comprising a connector coupled to the fuel passageway and configured to connect the fuel passageway to a fuel injector.

7. A system, comprising:
a transition piece support structure extending from a compressor casing and configured to support a combustor transition piece of a gas turbine engine; and
a fuel passageway integrated with the transition piece support structure.

8. The system of claim 7, wherein the transition piece support structure comprises a mounting bracket configured to support the combustor transition piece, and the fuel passageway is integrated with the mounting bracket.

9. The system of claim 7, wherein the fuel passageway comprises an internal conduit extending integrally through an interior of the transition piece support structure.

10. The system of claim 7, wherein the fuel passageway comprises a tube coupled to the transition piece support structure.

11. The system of claim 7, comprising the compressor casing, wherein the fuel passageway comprises an internal conduit extending integrally through a first interior of the compressor casing and extending integrally through a second interior of the transition piece support structure.

12. The system of claim 11, wherein the internal conduit is configured to wind through the first interior to enhance cooling of the compressor casing.

13. The system of claim 7, comprising:
the compressor casing;
a combustor support structure extending from the compressor casing and configured to support a combustor of the gas turbine engine; and
an additional fuel passageway integrated with the combustor support structure.

14. The system of claim 13, wherein the additional fuel passageway comprises an internal conduit extending integrally through an interior of the combustor support structure.

15. A system, comprising:
a combustor configured to combust a primary fuel source within a primary reaction zone and to combust a secondary fuel source within a secondary reaction zone downstream of the first reaction zone;
a primary fuel injector configured to inject the primary fuel source into the primary reaction zone;
a secondary fuel injector configured to inject the secondary fuel source into the second reaction zone;
a transition piece support structure configured to support a combustor transition piece connecting the combustor to a gas turbine engine;
a mounting bracket configured to mount the combustor transition piece to the transition piece support structure; and
a fuel passageway integrated with the mounting bracket and configured to route the secondary fuel source to the secondary fuel injector.

16. The system of claim 15, wherein the fuel passageway extends integrally through a first interior of the mounting bracket and integrally through a second interior of the transition piece support structure.

17. The system of claim 15, wherein the fuel passageway comprises a tube coupled to an exterior of the mounting bracket and coupled to another fuel passageway integrated with the transition piece support structure.

18. The system of claim 15, comprising a compressor casing, wherein the transition piece support structure extends from the compressor casing and the fuel passageway extends through the mounting bracket and the compressor casing.

19. The system of claim 15, comprising the combustor transition piece, wherein the secondary fuel injector extends through the combustor transition piece and into the secondary reaction zone.

20. The system of claim 15, comprising a gas turbine engine casing, wherein the secondary fuel injectors are enclosed within the gas turbine engine casing.
